(19) United States
(12) Patent Application Publication
(10) Pub. No.: US 2017/0097785 A1
(43) Pub. Date: Apr. 6, 2017

(54) DATA BLOCK SNAPSHOTS

(71) Applicant: HEWLETT PACKARD ENTERPRISE DEVELOPMENT LP, Houston, TX (US)

(72) Inventors: Amit C. Bhoomaraddi, Bangalore (IN); Alastair Slater, Britol (GB); Santosh Balaraj Bangalore, Bangalore (IN); Girish Chandra Belmanu Sadananda, Bangalore (IN)

(21) Appl. No.: 15/277,717

(22) Filed: Sep. 27, 2016

(30) Foreign Application Priority Data
Oct. 1, 2015 (IN) 5260/CHE/2015

(51) Int. Cl. G06F 3/06; G06F 11/14

(52) U.S. Cl. CPC G06F 3/0619; G06F 3/065; G06F 3/067; G06F 11/1435; G06F 11/1469

(57) ABSTRACT

Examples disclosed herein relate to storing a plurality of data blocks associated with a snapshot from a client storage volume, receiving a request to restore a subset of the data blocks associated with the snapshot, identifying a plurality of block addresses associated with the subset of the data blocks, and restoring the subset of the data blocks associated with the plurality of block addresses to the client storage volumes

### BACKGROUND

Data is often backed up from client devices and/or applications to logical storage devices. In some situations, the logical storage devices may comprise a plurality of storage blocks that store the data as a snapshot for later restoration to the client device and/or application.

### BRIEF DESCRIPTION OF THE DRAWINGS

In the accompanying drawings, like numerals refer to like components or blocks. The following detailed description references the drawings, wherein:

FIG. 1 is a block diagram of an example data block snapshot device;

FIG. 2 is a block diagram of example storage blocks;

FIG. 3 is a flowchart of an example of a method for providing data block snapshots; and

FIG. 4 is a block diagram of an example system for providing data block snapshots.

### DETAILED DESCRIPTION

Applications and client devices often use snapshots of data to create backup and restore points. For example, a client computer may create a snapshot of data stored on a local and/or logical storage volume. The snapshot may later be restored to the client computer in order to recover lost and/or corrupted data. The snapshot may also be used to restore the client computer to the state it was in at the time the snapshot was made. For example, a classroom computer may have a snapshot of data restored at the start of each class, so that students may use the client computer starting from a known data state.

In some situations, however, a client application may not want to restore a full snapshot. For example, if only one application has lost data, restoring an entire storage volume may take an undue amount of time or may erase other data changes made by other applications also using the volume. Even where an incremental backup of the other data changes has been made, restoring an entire volume may be needlessly time consuming and/or inefficient.

Restoring a partial snapshot of a subset of the volume's data may alleviate both of these problems. By identifying the data blocks in the snapshot associated with the desired backup data, those blocks may be restored while leaving other data on the volume unaffected.

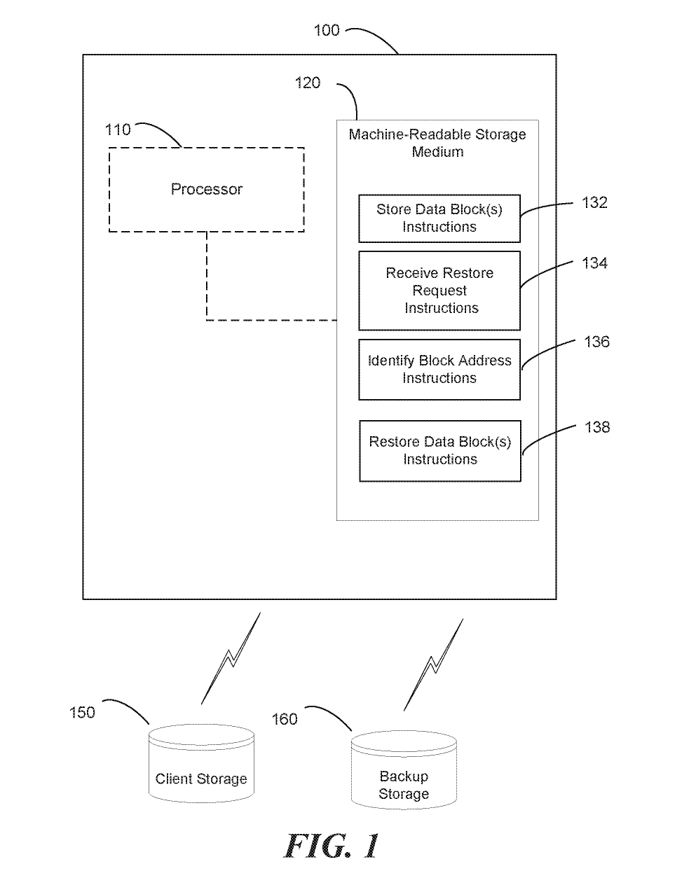

Referring now to the drawings, FIG. 1 is a block diagram of an example data block snapshot device 100 consistent with disclosed implementations. Data block snapshot device 100 may comprise a processor 110 and a non-transitory machine-readable storage medium 120. Data block snapshot device 100 may comprise a computing device such as a server computer, a desktop computer, a laptop computer, a handheld computing device, a smart phone, a tablet computing device, a mobile phone, a network device (e.g., a switch and/or router), or the like.

Processor 110 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 120. In particular, processor 110 may fetch, decode, and execute a plurality of store data block(s) instructions 132, receive restore request instructions 134, identify block address instructions 136, and restore data block(s) instructions 138 to implement the functionality described in detail below.

Executable instructions may comprise logic stored in any portion and/or component of machine-readable storage medium 120 and executable by processor 110. The machine-readable storage medium 120 may comprise both volatile and/or nonvolatile memory and data storage components. Volatile components are those that do not retain data values upon loss of power. Nonvolatile components are those that retain data upon a loss of power.

The machine-readable storage medium 120 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Store data block(s) instructions 132 may store a plurality of data blocks associated with a snapshot from a client storage volume. For example, a set of contiguous and/or non-contiguous memory addresses may be associated with data blocks stored on a client storage volume 150. Client storage volume 150 may be associated with, for example, an application, a virtual machine, and/or a client device such as a laptop, mobile device, desktop computer, tablet and/or server. Client storage volume 150 may provide data blocks associated with a physical and/or logical storage volume as a snapshot of the state of the data at a given time for backup to a backup storage volume 160. In various implementations, client storage volume 150 and backup storage volume 160 may be coupled to the same and/or different computing devices via physical, logical, and/or network connections. In some implementations, client storage volume 150 may comprise a disk array device that provides disk volumes for device 100 to use as storage. Such disk volumes may correspond to virtual/logical and/or physical disk devices.

Store data block(s) instructions 132 may comprise instructions to map a logical block address range to a corresponding block address range. For example, the addresses for a range of five data blocks on client storage volume 150 may map to addresses for a corresponding range of five data blocks on backup storage volume 160. The range of data blocks may, for example, be associated with a particular piece of data, such as an individual file, a memory page for an application, and/or a table in a database.

Receive restore request instructions 134 may receive a request to restore a subset of the data blocks associated with the snapshot. For example, a user and/or an administrator may request, such as through a backup application's user interface, that a particular portion of the snapshot of data be restored. The user interface may display a list of subsets of the snapshot available for restoration, such as individual files, restorable items, and/or tables of a database. In some implementations, a copy-on-write array function may be used to revert data blocks on client storage volume 150 to the data blocks of the partial snapshot on backup storage volume 160.

Identify block address instructions 136 may identify a plurality of block addresses associated with the subset of the data blocks. For example, a correspondence map may associate each address of the data blocks of the snapshot of data on client storage volume 150 with an address of a respective data block on backup storage volume 160. The particular blocks associated with the subset to be restored, such as an individual file, may be identified according to the addresses associated with the file's data blocks on the client storage volume 150 at the time the snapshot was made. The corresponding data blocks on backup storage volume 160 may then be selected.

Restore data block(s) instructions 138 may restore the subset of the data blocks associated with the plurality of block addresses to the client storage volume. For example, the selected blocks on backup storage volume 160 may be copied to client storage volume 150. In some implementations, the addresses associated with the data blocks of the snapshot may not have changed, and the data blocks can simply be written to their original locations. In other implementations, such as where client storage volume 150 represents a logical storage volume that may have been reassigned to new physical memory addresses, an offset from the start of the data blocks may be used to identify the location at which the backup data blocks should be written.

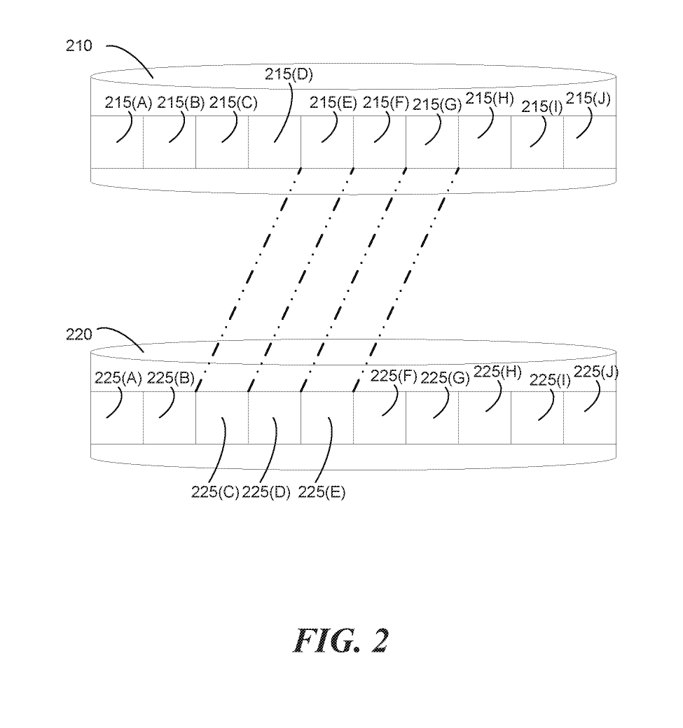

FIG. 2 is a block diagram of example storage blocks comprising a client storage volume 210 and a backup storage volume 220. Client storage volume 210 may comprise a plurality of client data blocks 215(A)-(J) and backup storage volume 220 may comprise a snapshot of client data blocks 215(A)-(J) stored as a plurality of backup data blocks 225(A)-(J). In some implementations, a correspondence map may associate data blocks from client storage volume 210 with data blocks in the snapshot stored on backup storage volume 220. For example, data blocks 225(C)-(E) on backup storage volume 220 may comprise a partial snapshot that corresponds with data blocks 215(E)-(G) on client storage volume 210. The partial snapshot may represent an individual file, for example, that may be retrieved from data blocks 225(C)-(E) and written to data blocks 215(E)-(G) if that file needed to be restored from the snapshot.

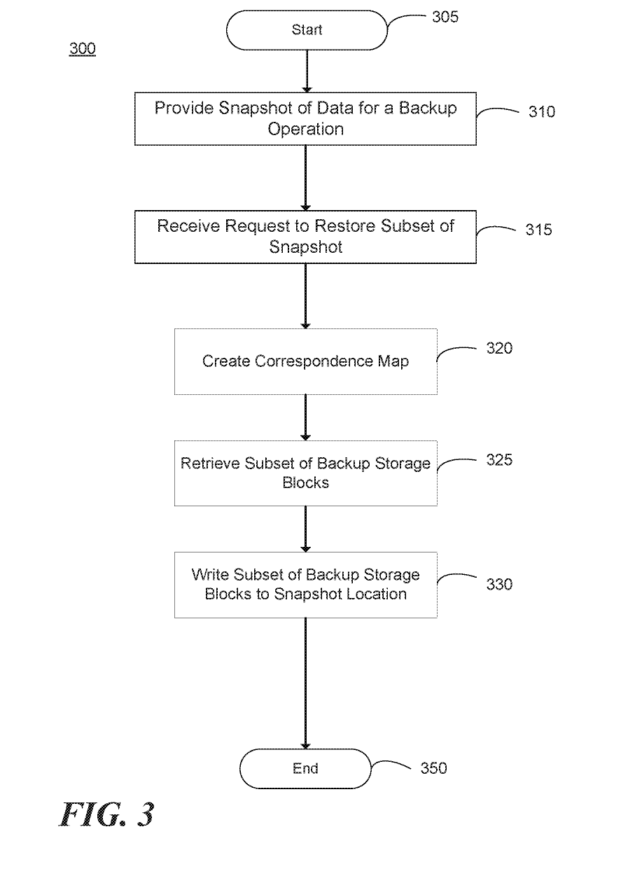

FIG. 3 is a flowchart of an example method 300 for providing data block snapshots consistent with disclosed implementations. Although execution of method 300 is described below with reference to the components of device 100, other suitable components for execution of method 300 may be used. For example, some and/or all stages of method 300 may be performed by client storage volume 150 and/or backup storage volume 160.

Method 300 may begin in stage 305 and proceed to stage 310 where device 100 may provide a snapshot of data stored on a plurality of client storage blocks for a backup operation to a plurality of backup storage blocks. The snapshot of data may, for example, comprise a data file associated with a client application and/or a table associated with a database application. In some implementations, the plurality of client storage blocks may comprise a first logical storage volume associated with a virtual machine. The client storage blocks and the backup storage blocks may each comprise a contiguous and/or a non-contiguous address space.

At stage 315, store data block(s) instructions 132 may store a plurality of data blocks associated with a snapshot from a client storage volume. For example, a set of contiguous and/or non-contiguous memory addresses may be associated with data blocks stored on a client storage volume 150. Client storage volume 150 may be associated with, for example, an application, a virtual machine, and/or a client device such as a laptop, mobile device, desktop computer, tablet and/or server. Client storage volume 150 may provide data blocks associated with a physical and/or logical storage volume as a snapshot of the state of the data at a given time for backup to a backup storage volume 160. In various implementations, client storage volume 150 and backup storage volume 160 may be coupled to the same and/or different computing devices via physical, logical, and/or network connections.

Store data block(s) instructions 132 may comprise instructions to map a logical block address range to a corresponding block address range. For example, the addresses for a range of five data blocks on client storage volume 150 may map to addresses for a corresponding range of five data blocks on backup storage volume 160. The range of data blocks may, for example, be associated with a particular piece of data, such as an individual file, a memory page for an application, and/or a table in a database.

Method 300 may then advance to stage 315 where device 100 may receive a request to restore a subset of the snapshot of data. For example, receive restore request instructions 134 may receive a request to restore a subset of the data blocks associated with the snapshot. For example, a user and/or an administrator may request, such as through a backup application's user interface, that a particular portion of the snapshot of data be restored. The user interface may display a list of subsets of the snapshot available for restoration, such as individual files and/or tables of a database.

Method 300 may then advance to stage 320 where device 100 may create a correspondence map of the plurality of client storage blocks to the plurality of backup storage blocks. For example, identify block address instructions 136 may identify a plurality of block addresses associated with the subset of the data blocks. For example, a correspondence map may associate each address of the data blocks of the snapshot of data on client storage volume 150 with an address of a respective data block on backup storage volume 160. The particular blocks associated with the subset to be restored, such as an individual file, may be identified according to the addresses associated with the file's data blocks on the client storage volume 150 at the time the snapshot was made. The corresponding data blocks on backup storage volume 160 may then be selected.

Method 300 may then advance to stage 325 where device 100 may retrieve a subset of the plurality of backup storage blocks corresponding to the subset of the snapshot of data according to the correspondence map. For example, the data blocks associated with the subset of the snapshot of data may be copied into memory and checked for integrity, such as by comparing the blocks to a checksum.

Method 300 may then advance to stage 330 where device 100 may write the subset of the plurality of backup storage blocks to a location associated with the snapshot of data. For example, restore data block(s) instructions 138 may restore the subset of the data blocks associated with the plurality of block addresses to the client storage volume. The selected blocks on backup storage volume 160 may be copied to client storage volume 150. In some implementations, restore data block instructions 138 may create an array-based partial snapshot of the selected block range from backup storage volume 160. In some implementations, the addresses associated with the data blocks of the snapshot may not have changed, and the data blocks can simply be written to their original locations. In other implementations, such as where client storage volume 150 represents a logical storage volume that may have been reassigned to new physical memory addresses, an offset from the start of the data blocks may be used to identify the location at which the backup data blocks should be written.

In some implementations, writing the subset of the plurality of backup storage blocks to the location associated with the snapshot of data comprises writing the subset of the plurality of backup storage blocks to a second logical storage volume associated with a virtual machine. For example, a virtual machine may have been migrated, restarted, and/or assigned a different logical storage volume such that the addresses associated with the data blocks to be restored have changed. An offset from the start of the volume and/or full snapshot of data blocks may be used in accordance with the correspondence map to locate the relative start position for the restored data blocks to be written.

Method 300 may then end at stage 350.

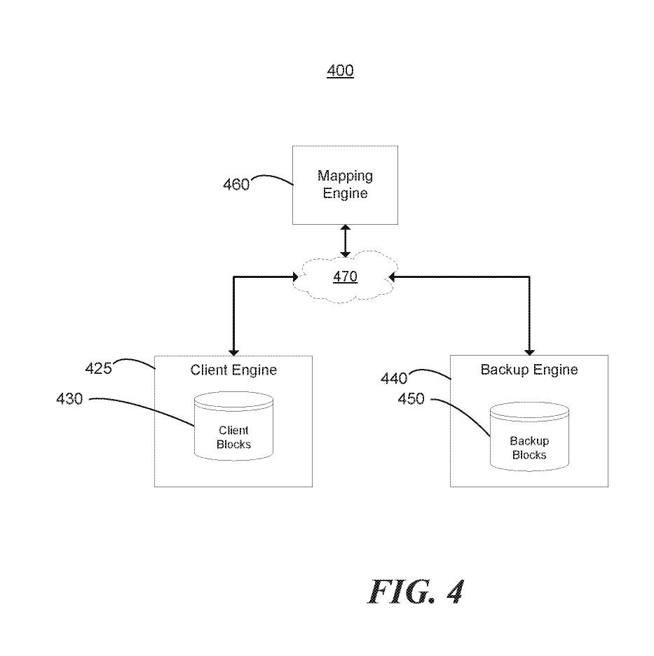

FIG. 4 is a block diagram of an example system 400 for providing a data block snapshot. System 400 may comprise a client engine 425 comprising a plurality of client storage blocks 430, a backup engine 440 comprising a plurality of backup storage blocks 450 and a mapping engine 460. Client engine 425, backup engine 440 and snapshot engine 460 may be associated with a single computing device and/or may be communicatively coupled such as via a direct connection, bus, or network 470. Each of engines 425, 440, and 460 may comprise hardware and/or software associated with computing devices.

Client engine 425 may provide a snapshot of data stored on plurality of client storage blocks 430 for a backup operation, request a subset of the snapshot of data to be restored, and write the subset of the snapshot of data to be restored to a subset of the plurality of client storage blocks 430. The data may be stored by a client such as a process, application, user, virtual machine, etc. The snapshot may represent a state of the data associated with the client at a given point in time and may be provided to the backup engine 440 for later restoration. In some implementations, individual components of the snapshot such as files, database tables, memory pages, etc. may be identified and catalogued for their memory address within the snapshot at the time the snapshot is provided to the backup engine 440. The catalog may be identified and stored by client engine 425 and/or backup engine 440.

Backup engine 440 may receive the snapshot of data for the backup operation, store the snapshot of data on plurality of backup storage blocks 450, and provide the subset of the snapshot of data to be restored. Backup engine 440 may execute store data block(s) instructions 132 to store a plurality of data blocks associated with a snapshot from a client storage volume. For example, a set of contiguous and/or non-contiguous memory addresses may be associated with data blocks stored on a client storage volume, such as client storage blocks 430. Client storage blocks 430 may be associated with, for example, an application, a virtual machine, and/or a client device such as a laptop, mobile device, desktop computer, tablet and/or server. Client storage blocks 430 may comprise data blocks associated with a physical and/or logical storage volume as a snapshot of the state of the data at a given time for backup to backup storage blocks 450.

Store data block(s) instructions 132 may comprise instructions to map a logical block address range to a corresponding block address range. For example, the addresses for a range of five data blocks on client storage blocks 430 may map to addresses for a corresponding range of five data blocks on backup storage blocks 450. The range of data blocks may, for example, be associated with a particular piece of data, such as an individual file, a memory page for an application, and/or a table in a database.

In some implementations, backup engine 440 may execute restore data block(s) instructions 138 to restore the subset of the data blocks associated with the plurality of block addresses to the client storage blocks 430. For example, the selected blocks of backup storage blocks 450 may be copied to their respective client storage blocks 430. In some implementations, the addresses associated with the data blocks of the snapshot may not have changed, and the data blocks can simply be written to their original locations. In other implementations, such as where client storage blocks 430 are associated with a logical storage volume that may have been reassigned to new physical memory addresses, an offset from the start of the data blocks may be used to identify the location at which the backup data blocks should be written.

Mapping engine 460 may create a correspondence map of each of the plurality of client storage blocks 430 to a respective one of the plurality of backup storage blocks 450 and identify, to the backup engine 440, a subset of the plurality of backup storage blocks 450 associated with the subset of the snapshot of data to be restored according to the created correspondence map. For example, with respect to FIG. 2, the correspondence map may associate blocks 225(C)-(E) stored in backup storage blocks 430 with blocks 215(D)-(F) in a snapshot from client storage blocks 430.

Mapping engine 460 may execute identify block address instructions 136 to identify a plurality of block addresses associated with the subset of the data blocks. For example, a correspondence map may associate each address of the data blocks of the snapshot of data on client storage blocks 430 with an address of a respective data block on backup storage blocks 450. The particular blocks associated with the subset to be restored, such as an individual file, may be identified according to the addresses associated with the file's data blocks on the client storage blocks 430 at the time the snapshot was made. The corresponding data blocks on backup storage blocks 450 may then be selected.

The disclosed examples may include systems, devices, computer-readable storage media, and methods for data block snapshot. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

I/we claim:

1. A non-transitory machine-readable storage medium comprising instructions to:
store a plurality of data blocks associated with a snapshot from a client storage volume;
receive a request to restore a subset of the data blocks associated with the snapshot;
identify a plurality of block addresses associated with the subset of the data blocks; and
restore the subset of the data blocks associated with the plurality of block addresses to the client storage volume.

2. The non-transitory machine-readable medium of claim 1, wherein the snapshot is associated with a plurality of contiguous block addresses on the client storage volume comprising a logical block address range.

3. The non-transitory machine-readable medium of claim 2, wherein the instructions to store the plurality of data blocks associated with the snapshot comprise instructions to map the logical block address range to a corresponding block address range.

4. The non-transitory machine-readable medium of claim 3, wherein the subset of the data blocks comprise a subset of the contiguous block addresses on the client storage volume.

5. The non-transitory machine-readable medium of claim 4, wherein the instructions to identify the plurality of block addresses associated with the subset of the data blocks comprise instructions to identify, according to the map of the logical block address range to the corresponding block address range, a subset of the corresponding block address range associated with the subset of the contiguous block addresses on the client storage volume.

6. The non-transitory machine-readable medium of claim 5, wherein the instructions to restore the subset of the data blocks associated with the plurality of block addresses to the client storage volume comprise instructions to write the subset of the data blocks associated with the subset of the corresponding block address range to the subset of the contiguous block addresses on the client storage volume.

7. A computer-implemented method, comprising:
providing a snapshot of data stored on a plurality of client storage blocks for a backup operation to a plurality of backup storage blocks;
receiving a request to restore a subset of the snapshot of data;
creating a correspondence map of the plurality of client storage blocks to the plurality of backup storage blocks;
retrieving a subset of the plurality of backup storage blocks corresponding to the subset of the snapshot of data according to the correspondence map; and
writing the subset of the plurality of backup storage blocks to a location associated with the snapshot of data.

8. The computer-implemented method of claim 7, wherein the snapshot of data is associated with a client application.

9. The computer-implemented method of claim 8, wherein the subset of the snapshot of data is associated with a data file of the client application.

10. The computer-implemented method of claim 8, wherein the client application comprises a database application and the subset of the snapshot of data is associated with a table of the database application.

11. The computer-implemented method of claim 7, wherein the plurality of client storage blocks comprise a contiguous address space.

12. The computer-implemented method of claim 11, wherein the plurality of backup storage blocks comprise a non-contiguous address space.

13. The computer-implemented method of claim 8, wherein the plurality of client storage blocks comprise a first logical storage volume associated with a virtual machine.

14. The computer-implemented method of claim 13, wherein writing the subset of the plurality of backup storage blocks to the location associated with the snapshot of data comprises writing the subset of the plurality of backup storage blocks to a second logical storage volume associated with the virtual machine.

15. A system, comprising:
a client engine to:
provide a snapshot of data stored on a plurality of client storage blocks for a backup operation,
request a subset of the snapshot of data to be restored, and
write the subset of the snapshot of data to be restored to a subset of the plurality of client storage blocks;
a backup engine to:
receive the snapshot of data for the backup operation,
store the snapshot of data on a plurality of backup storage blocks, and
provide the subset of the snapshot of data to be restored;
a snapshot engine to:
create a correspondence map of each of the plurality of client storage blocks to a respective one of the plurality of backup storage blocks, and
identify, to the backup engine, a subset of the plurality of backup storage blocks associated with the subset of the snapshot of data to be restored according to the created correspondence map.
